(19) United States
(12) Patent Application Publication
(10) Pub. No.: US 2026/0231958 A1
(43) Pub. Date: Aug. 13, 2026

(54) BREAD IMPROVER COMPOSITION, BREAD DOUGH COMPOSITION COMPRISING SAME AND BREAD PREPARED USING SAME

(71) Applicant: CJ FOODVILLE CO., LTD., Seoul (KR)

(72) Inventor: Dong Min SHIN, Namyangju-si Gyeonggi-do (KR)

(73) Assignee: CJ FOODVILLE CO., LTD., Seoul (KR)

(21) Appl. No.: 19/536,430

(22) Filed: Feb. 11, 2026

(30) Foreign Application Priority Data
Feb. 12, 2025 (KR) 10-2025-0018154
Feb. 10, 2026 (KR) 10-2026-0026741

(51) Int. Cl. A21D 8/04; A21D 13/02; A21D 13/42

(52) U.S. Cl. CPC A21D 8/042; A21D 13/02; A21D 13/42

(57) ABSTRACT

The present invention relates to a bread improver composition, a bread dough composition comprising the same, and bread prepared therefrom. In the present invention, by preparing bread by applying a bread improver composition comprising vitamin C, amylase, and hemicellulase to a bread dough composition together with wheat flour, it is possible to prepare European-style hard bread having improved volume, a thin outer crust with improved crust, internal crumb texture, and flavor.

### CROSS-REFERENCE TO RELATED APPLICATIONS

This application claims the priorities to Korean Patent Application No. 10-2025-0018154 filed on Feb. 12, 2025, and Korean Patent Application No. 10-2026-0026741 filed on Feb. 10, 2026, the entire contents of which are herein incorporated by reference.

### BACKGROUND

### Field

The present invention relates to a bread improver composition, a bread dough composition comprising the same, and bread prepared therefrom, and more specifically, to a bread improver composition comprising vitamin C, amylase and hemicellulase, a bread dough composition comprising the bread improver composition and wheat flour, and bread prepared from the bread dough composition.

### Description of the Related Art

Bread refers to a food prepared by kneading cereal flour such as wheat flour with a liquid and then baking the kneaded product, and may be classified into fermented bread that is slowly fermented using yeast and unfermented bread that is rapidly leavened using baking powder. Among these, fermented bread refers to bread manufactured by fermenting a dough prepared by mixing cereal flour with salt, water, yeast, and the like, and then baking the fermented dough in an oven.

In the case of fermented bread, not only the characteristics of raw materials such as the type and ratio of ingredients but also the fermentation process greatly affect taste, flavor, and volume, and thus, the fermentation process is very important in order to prepare high-quality bread. When fermented bread is prepared by fermentation using yeast alone, the fermentation time is slow, there are limitations in improving texture and volume, and it is difficult to apply to mass production, and thus, in order to compensate for such disadvantages, an improver is used.

When a bread improver is used, the fermentation time can be shortened, and thus it is suitable for mass production and has an advantage in that volume is improved. In this regard, Korean Patent Publication No. 10-2006-0132409 discloses a bread improver having an excellent volume-increasing effect by including vitamin C and a hybrid of layered metal hydroxide and a vitamin C release delaying agent such as lecithin, and Korean Patent Publication No. 10-2023-0046247 describes an improver for shortening a bread-making process by including ascorbic acid, ascorbic acid oxidase, glucose oxidase, and alpha-amylase.

When an improver is added as in the above technologies, effects of process shortening and volume increase may be exhibited, however, conventional bread improvers are mainly intended to improve bread volume, and thus have a limitation in that, when applied to European-style hard bread such as ciabatta, campagne, batard, and baguette, in which crust of an outer surface and internal crumb texture are important, they do not have a significant effect on improving the characteristics of the crust and internal crumb texture.

Accordingly, there is a need for development of an improver capable of preparing bread having excellent volume, internal crumb texture, and flavor while improving crust by forming a thin outer crust during preparation of European-style hard bread, and bread dough and bread using the improver.

### SUMMARY

An object of the present invention is to prepare a bread improver composition capable of improving crust by forming a thin outer crust during preparation of European-style hard bread, while enhancing volume, internal crumb texture, and flavor.

Another object of the present invention is to provide a bread dough composition comprising the bread improver composition and wheat flour.

Still another object of the present invention is to provide bread prepared from a bread dough composition comprising the bread improver composition.

In order to achieve the above objects, a bread improver composition of the present invention comprises vitamin C (ascorbic acid), amylase, and hemicellulase.

In the present invention, the amylase may comprise at least one selected from alpha-amylase (α-amylase) and glucoamylase.

In the present invention, the hemicellulase may comprise xylanase.

In the present invention, the vitamin C may be comprised in an amount of 10 to 40 wt % based on a total weight of the improver composition.

In the present invention, the amylase may be comprised in an amount of 20 to 60 wt % based on a total weight of the improver composition.

In the present invention, a weight ratio of the alpha-amylase to the glucoamylase may be 90:10 to 60:40.

In the present invention, the hemicellulase may be comprised in an amount of 20 to 60 wt % based on a total weight of the improver composition.

In addition, a bread dough composition of the present invention comprises the bread improver composition; and wheat flour.

In the present invention, the bread improver composition may be comprised in an amount of 0.1 to 2.0 parts by weight based on 100 parts by weight of the wheat flour.

In the present invention, the wheat flour may comprise French wheat flour and strong flour.

In the present invention, a weight ratio of the French wheat flour to the strong flour may be 20:80 to 90:10.

In addition, bread of the present invention is prepared from the bread dough composition.

In the present invention, the bread may be European-style hard bread.

In the present invention, a bread improver composition comprising vitamin C, amylase, and hemicellulase can not only improve crust by forming a thin outer crust during bread-making, but also improve volume, internal crumb texture, and flavor of bread.

In the present invention, European-style hard bread having a thin outer crust and improved crust, volume, internal crumb texture, and flavor can be prepared from a bread dough composition comprising the bread improver composition.

### BRIEF DESCRIPTION OF THE DRAWINGS

FIG. 1 is a photograph of a finished French baguette prepared by varying a type and amount of an improver composition according to one embodiment of the present invention.

FIG. 2 is a cross-sectional photograph of a finished French baguette prepared by varying a type and amount of an improver composition according to one embodiment of the present invention.

FIG. 3 is an enlarged photograph of a cross-section of a finished French baguette prepared by varying a type and amount of an improver composition according to one embodiment of the present invention.

### DETAILED DESCRIPTION OF THE PREFERRED EMBODIMENT

Hereinafter, specific embodiments of the present invention will be described in more detail. Unless otherwise defined, all technical and scientific terms used in the present specification have the same meanings as those commonly understood by a person skilled in the art to which the present invention pertains.

In the specification and claims of the present invention, the expressions “comprise,” “have,” and variations thereof mean that the described features or components are present, and unless otherwise specified, do not exclude the possibility that one or more other features or components may be added.

In the specification and claims of the present invention, singular expressions are to be construed as including plural expressions unless the context clearly indicates otherwise, and plural expressions are also to be construed as including singular expressions unless the context clearly indicates otherwise.

Numerical ranges expressed in the specification and claims of the present invention, unless otherwise defined, include the lower limit, the upper limit, and all values therebetween, and are to be construed as including all possible numerical ranges obtained by combining the lower limit and the upper limit.

Expressions indicating degree, such as “about,” used in the specification of the present invention are to be construed as including an allowable error range of the corresponding numerical value.

The present invention relates to a bread improver composition, a bread dough composition comprising the same, and bread prepared from the dough composition.

Conventional improvers are intended to shorten a process and increase volume, and in particular, when an improver is applied to dough in order to prepare European-style hard bread such as ciabatta, campagne, batard, and baguette, improvement of crust of an outer surface and internal crumb texture of the prepared bread is insufficient, and thus a significant effect cannot be exhibited.

Accordingly, the present invention has come to disclose a bread improver composition comprising vitamin C, amylase, and hemicellulase, and it has been found that, from the bread improver composition and a bread dough composition comprising the same, bread in which an outer surface crust is formed thin to improve crust, and volume, internal crumb texture, and flavor are improved can be implemented.

The bread improver composition of the present invention may comprise vitamin C (ascorbic acid), amylase, and hemicellulase.

In the present invention, the vitamin C may serve as an oxidizing agent. Specifically, when the improver composition is applied to bread dough, an oxidation reaction is performed in the dough by the vitamin C, thereby promoting formation of bonds between gluten proteins in the dough and improving structural stability, from which gas retention capacity of the dough may be improved, and ultimately, volume of bread prepared may be improved. The vitamin C may be prepared in a manner commonly used in the same technical field or may be used by purchasing a commercially available product.

In the present invention, the vitamin C may be comprised in an amount of 10 to 40 wt % based on a total weight of the improver composition. Specifically, the vitamin C may have a lower limit of 10 wt % or greater, 15 wt % or greater, 20 wt % or greater, or a value between these numerical ranges, and an upper limit of 40 wt % or less, 35 wt % or less, 30 wt % or less, or a value between these numerical ranges, based on the total weight of the improver composition. Preferably, when the vitamin C is comprised in an amount of 20 to 30 wt % or a value between these numerical ranges based on the total weight of the improver composition, stability of bread dough as well as volume and internal crumb texture of bread finally prepared may be excellent.

In the present invention, the amylase is a starch-hydrolyzing enzyme and can hydrolyze starch contained in grain raw material such as wheat flour into low-molecular carbohydrates or simple sugars such as dextrin, oligosaccharide, and glucose. Specifically, when the improver composition is applied to bread dough, the amylase can hydrolyze starch in the dough into simple sugar available to yeast or low-molecular carbohydrate for additional saccharification. Fermentation of the dough proceeds by yeast, and CO₂ generated expands the dough and can form pores more uniformly, and ultimately, bread prepared may have excellent volume, crust, internal crumb texture, and flavor.

In the present invention, the amylase may comprise at least one selected from alpha-amylase (α-amylase) and glucoamylase, and the alpha-amylase is non-bacterial, and preferably, both alpha-amylase and glucoamylase may be comprised. Specifically, the alpha-amylase can cleave α-1,4-glycosidic bonds of starch contained in grain raw material such as wheat flour internally (endo) to convert the starch into low-molecular carbohydrates such as dextrin and oligosaccharide, and the glucoamylase mainly cleaves α-1,4-glycosidic bonds at non-reducing ends (exo) of dextrin and oligosaccharide, and depending on conditions, can also cleave some α-1,6-glycosidic bonds, thereby finally producing glucose, which is a simple sugar.

As described above, the non-bacterial alpha-amylase of the present invention can provide a substrate available to yeast by hydrolyzing starch to generate dextrin. The generated dextrin can promote yeast activity during a fermentation process to improve a fermentation rate, whereby gas generation and retention of dough can be smoothly performed, and during a baking process, crust formation can proceed rapidly to maintain a crispy texture suitable for European-style hard bread while improving moisture retention.

In the present invention, when a bread improver composition comprising the alpha-amylase and the glucoamylase is applied to bread dough, starch contained in grain raw material such as wheat flour in the dough is hydrolyzed by the alpha-amylase to form dextrin, oligosaccharide, and the like, and the glucoamylase can further saccharify the same to generate glucose. Yeast can perform fermentation and CO₂ generation in the dough using the glucose, and ultimately, bread having a uniform pore structure and improved volume, crust, internal crumb texture, and flavor can be prepared from the bread dough.

In the present invention, the amylase may be comprised in an amount of 20 to 60 wt % based on a total weight of the improver composition. Specifically, the amylase may have a lower limit of 20 wt % or greater, 25 wt % or greater, 30 wt % or greater, 35 wt % or greater, or a value between these numerical ranges, and an upper limit of 60 wt % or less, 55 wt % or less, 50 wt % or less, 45 wt % or less, or a value between these numerical ranges, based on the total weight of the improver composition. Preferably, when the amylase is comprised in an amount of 30 to 60 wt %, more preferably 35 to 45 wt %, or a value between these numerical ranges based on the total weight of the improver composition, fermentation of bread dough can be stably and actively performed, and ultimately, volume, crust, internal crumb texture, and flavor of bread prepared can be excellent. At this time, an activity of the amylase may be 10 to 10,000 U/g, preferably 100 to 5,000 U/g, or a value between these numerical ranges. For reference, in the unit U/g, U refers to a unit substantially corresponding to enzyme activity measured in an activity unit commonly used for each enzyme depending on a type of enzyme (FAU, FXU, or AGU), and for example, activity of amylase may be expressed as FAU/g or AGU/g.

In addition, in the present invention, a weight ratio of the alpha-amylase to the glucoamylase may be 90:10 to 60:40. Preferably, when comprised at a weight ratio of 85:15 to 65:35, more preferably 80:20 to 70:30, when the improver composition is applied to dough thereafter, glucose as a substrate for yeast can be generated more effectively from hydrolysis of starch, and through yeast fermentation and CO₂ generation, volume, internal crumb texture, and flavor of bread prepared can be further improved.

In the present invention, the hemicellulase collectively refers to an enzyme group that hydrolyzes non-starch polysaccharide derived from a plant cell wall, specifically hemicellulose, and when the bread improver composition is applied to bread dough, the hemicellulase can hydrolyze hemicellulose present in wheat flour in the dough. Hemicellulose has various types of constituent sugars and bonding forms of sugars, and the hemicellulase may comprise at least one hemicellulose-hydrolyzing enzyme.

Preferably, the hemicellulase may comprise xylanase that degrades arabinoxylan, which is a main component of hemicellulose in wheat flour. In addition, the hemicellulase may further comprise at least one selected from beta-xylosidase (β-xylosidase), beta-glucanase (β-glucanase), beta-mannanase (β-mannanase), alpha-galactosidase (α-galactosidase), alpha-L-arabinofuranosidase (α-L-arabinofuranosidase), and acetyl xylan esterase, in addition to xylanase.

Hemicellulose in wheat flour can affect water-binding capacity and viscosity of dough. When the improver composition comprising hemicellulase is applied to bread dough, the hemicellulase can affect water behavior and viscosity characteristics of dough by partially hydrolyzing hemicellulose in wheat flour. Accordingly, processability of dough, fermentation stability, and pore structure of final bread can be changed, and such changes can affect crust formation behavior and color, and formation of internal crumb texture during a baking process of bread dough.

In addition, characteristics such as changes in dough physical properties and moisture distribution by the hemicellulase can indirectly contribute to forming a thinner and crispier crust with appropriate browning when crust is formed by a Maillard reaction between reducing sugar generated from starch hydrolysis by amylase and amino groups of protein and amino acid in wheat flour during a baking process of bread dough.

As described above, the hemicellulase of the present invention can act together with glucoamylase to contribute to physical properties and structure formation of dough by regulating structures of starch and non-starch polysaccharide in the dough, and specifically, by degrading hemicellulose contained in wheat flour to assist formation of a gluten bonding structure and network through mixing and fermentation processes, and by imparting flexibility to a dough structure, can induce formation of a more uniform pore structure as compared with dough to which an improver is not added. Bread finally prepared can exhibit advantageous characteristics in terms of volume formation. That is, by an enzyme combination of alpha-amylase, glucoamylase, and hemicellulase as described above, the bread improver composition of the present invention can provide a crispy texture suitable for European-style hard bread by allowing crust formation to proceed rapidly, while preventing excessive loss of moisture so that drying of an internal structure is prevented.

In the present invention, the hemicellulase may be comprised in an amount of 20 to 60 wt % based on a total weight of the improver composition. Specifically, the hemicellulase may have a lower limit of 20 wt % or greater, 25 wt % or greater, 30 wt % or greater, 35 wt % or greater, or a value between these numerical ranges, and an upper limit of 60 wt % or less, 55 wt % or less, 50 wt % or less, 45 wt % or less, or a value between these numerical ranges, based on the total weight of the improver composition. Preferably, when the hemicellulase is comprised in an amount of 30 to 60 wt %, more preferably 35 to 45 wt %, or a value between these numerical ranges based on the total weight of the improver composition, fermentation of bread dough can be stably performed, and ultimately, volume, crust, internal crumb texture, and flavor of bread prepared can be excellent. At this time, an activity of the hemicellulase may be 10 to 10,000 U/g, preferably 100 to 5,000 U/g, or a value between these numerical ranges. For reference, in the unit U/g, U refers to a unit substantially corresponding to enzyme activity measured in an activity unit commonly used for each enzyme depending on a type of enzyme (FAU, FXU, or AGU), and for example, activity of hemicellulase may be expressed as FXU/g.

In one preferred embodiment of the bread improver composition of the present invention, when vitamin C, alpha-amylase, glucoamylase, and xylanase are simultaneously comprised, the composition can act together with wheat flour in a bread dough composition, and through a series of hydrolysis processes by alpha-amylase and glucoamylase, reducing sugar is generated, and at the same time, physical properties and moisture distribution of the dough composition are regulated by xylanase, whereby bread finally prepared can exhibit more excellent results overall in terms of volume, thin outer crust, internal crumb texture, and flavor.

In another embodiment, a bread dough composition of the present invention comprises the bread improver composition; and wheat flour. As described above, the bread improver composition comprising vitamin C, amylase, and hemicellulase is comprised in a bread dough composition together with wheat flour, and can implement bread having excellent volume, crust, internal crumb texture, and flavor from the dough composition.

In the bread dough composition, the bread improver composition may be comprised in an amount of 0.1 to 2.0 parts by weight based on 100 parts by weight of the wheat flour. The bread improver composition may have a lower limit of 0.1 parts by weight or greater, 0.5 parts by weight or greater, 0.8 parts by weight or greater, or a value between these numerical ranges, and an upper limit of 2.0 parts by weight or less, 1.8 parts by weight or less, 1.5 parts by weight or less, 1.2 parts by weight or less, or a value between these numerical ranges. Preferably, the bread improver composition may be comprised in an amount of 0.5 to 1.5 parts by weight, more preferably 0.8 to 1.2 parts by weight, based on 100 parts by weight of the wheat flour. By adjusting a content of the improver composition as in the numerical ranges described above, bread finally prepared from the bread dough composition can have excellent volume, while having a thin outer crust to improve crust, and excellent internal crumb texture and flavor. On the other hand, when the improver composition is insufficient, bread finally prepared can have reduced volume and size and reduced crust of an outer crust, resulting in degraded texture, and when comprised in an excessive amount, stability of the dough composition can be reduced, resulting in reduced volume of bread finally prepared and excessive browning.

As one preferred specific example, when the improver composition is comprised in the bread dough composition in an amount of 1.0 part by weight based on 100 parts by weight of the wheat flour, European-style hard bread such as baguette finally prepared can exhibit the most excellent results in all aspects of volume, crust, internal crumb texture, and flavor.

In the present invention, the wheat flour may comprise at least one selected from bread-making wheat flour, and specifically may comprise at least one selected from strong flour, medium flour, whole wheat flour, rye flour, whole grain flour, and French wheat flour. Preferably, the wheat flour may comprise French wheat flour and strong flour, and by using French wheat flour together with strong flour, more excellent volume, flavor, crust, and internal crumb texture can be exhibited when preparing European-style hard bread such as baguette.

In the present invention, the French wheat flour is wheat flour classified according to French milling standards, and refinement degree and milling characteristics may be defined based on ash content. The ash content of the French wheat flour may generally be 0.40 to 1.60 wt %, and preferably, French wheat flour having an ash content of 0.50 to 1.20 wt % or a value between these numerical ranges may be used. In the bread dough composition of the present invention, ductility of the dough composition can be adjusted by using French wheat flour having selectable ash content as described above. As a specific example, the French wheat flour may comprise T45, T55, T65, T80, T110, T150, or a mixture thereof, and French wheat flour having an ash content of 0.50 to 1.20 wt % may correspond to flour of T55 to T110 according to French milling standards. When French wheat flour having a relatively high ash content is comprised, a problem of reduced gas retention capacity and reduced volume of dough can be more alleviated, and by contributing to mitigation of oven spring loss, volume of a final product can be further improved.

In the present invention, the strong flour refers to wheat flour having high protein content and high gluten-forming ability among bread-making wheat flours, and may mean wheat flour corresponding to strong flour according to milling standards. The strong flour may mean wheat flour having a protein content of 10 to 15 wt % based on dry weight, and preferably, strong flour having a protein content of 11 to 13 wt % may be used. As a specific example, the strong flour may be wheat flour corresponding to a wet gluten content of 25 to 35 wt %, preferably 28 to 35 wt %. In the bread dough composition of the present invention, elasticity of the dough composition can be adjusted by using strong flour having high protein content or high gluten content as described above, and in particular, when strong flour having a protein content of 11 to 13 wt % or a wet gluten content of 28 to 35 wt % is used, it may be more preferable to prepare a bread dough composition for European-style hard bread such as baguette.

As described above, when comprised in a bread dough composition together with strong flour and French wheat flour, the bread dough composition of the present invention can have ductility as well as elasticity. Specifically, in the present invention, a weight ratio of the French wheat flour to the strong flour may be 20:80 to 90:10. Preferably, the French wheat flour and the strong flour may be blended at a weight ratio of 30:70 to 80:20, more preferably 60:40 to 80:20, most preferably 65:35 to 75:25, or a value between these numerical ranges. A blending ratio of these wheat flours, together with a content of the bread improver composition, can greatly affect texture and flavor such as crust and internal crumb texture of a bread dough composition and bread prepared therefrom, and flavor of bread prepared under a condition where a content of French wheat flour is higher than that of strong flour can be more excellent.

In addition, in the present invention, the bread dough composition may further comprise, in addition to wheat flour and the bread improver, at least one ingredient selected from the group consisting of water, yeast, salt, malt extract, gluten, skim milk powder, soybean, milk, butter, sugar, and honey. Preferably, the bread dough composition may comprise water, wheat flour, the bread improver composition, yeast, salt, malt extract, and gluten.

In the present invention, water serves to mix all ingredients to bind into one bread dough composition, and may be comprised in an amount of 40 to 100 parts by weight based on 100 parts by weight of the wheat flour. Preferably, the water may be comprised in an amount of 45 to 85 parts by weight, more preferably 55 to 75 parts by weight, most preferably 60 to 70 parts by weight, or a value between these numerical ranges, based on 100 parts by weight of the wheat flour. When the above conditions are satisfied, physical properties of the bread dough composition can exhibit a texture suitable for bread-making, and volume, crust, internal crumb texture, and flavor of bread prepared can be excellent.

In the present invention, the yeast serves to assist fermentation of the bread dough composition and to provide volume to bread, and activity of the yeast can be promoted by amylase and hemicellulase of the bread improver composition. Specifically, the yeast may be comprised in an amount of 0.1 to 5 parts by weight, preferably 1 to 5 parts by weight, more preferably 1.5 to 3 parts by weight, most preferably 2.0 to 2.5 parts by weight, or a value between these numerical ranges, based on 100 parts by weight of the wheat flour, in consideration of flavor and fermentability of bread.

In the present invention, the salt not only imparts flavor to bread, but can also strengthen a gluten structure to increase volume of bread and regulate a fermentation rate during fermentation. The salt may be comprised in an amount of 0.1 to 5 parts by weight, preferably 1 to 5 parts by weight, more preferably 1 to 2.5 parts by weight, most preferably 1.5 to 2.0 parts by weight, or a value between these numerical ranges, based on 100 parts by weight of the wheat flour.

In the present invention, the malt extract is in a powder form and is a raw material obtained by saccharifying and extracting malt and concentrating the same, and can serve to assist fermentation of yeast by providing sugar available for fermentation. The malt extract may be comprised in an amount of 0.1 to 2 parts by weight, preferably 0.1 to 1 part by weight, or a value between these numerical ranges, based on 100 parts by weight of the wheat flour. In addition, in the case of the malt extract, it may be preferable to add the same in a dispersed manner rather than adding the same all at once during mixing of raw materials.

In addition, the bread dough composition may comprise at least one selected from nuts and dried fruit as a subsidiary ingredient. The nuts and dried fruit may be comprised in a crushed or powdered form, and as a non-limiting example, may comprise walnut powder or walnut granules. The subsidiary ingredient may be comprised in the bread dough composition within a range that does not impair fermentation of the bread dough composition and characteristics such as texture and volume of bread finally prepared, for example, such that a total content of the subsidiary ingredient is 1 to 20 parts by weight, preferably 5 to 15 parts by weight, based on 100 parts by weight of the wheat flour.

In addition, the bread dough composition may independently comprise other additives, for example, an emulsifying stabilizer such as propylene glycol alginate (PGA) or a coloring agent, in an amount of 0.01 to 5 parts by weight based on 100 parts by weight of the wheat flour.

In addition, in order to supplement flavor and texture of the bread dough composition or to adjust preference or nutritional components, the bread dough composition may further comprise at least one additional ingredient selected from fats and oils such as egg (whole egg or yolk), fats such as margarine, shortening, and oil, and alternative sweeteners such as allulose, stevia, and sucralose.

In the present invention, the bread dough composition may be prepared, at a stage prior to baking into bread, in a form in which raw materials are mixed and bound together into one. The form of the bread dough composition may be unshaped dough itself, or may be a form shaped into a desired bread shape as needed. In addition, the bread dough composition may exist in a refrigerated or frozen state, and in addition, the bread dough composition may exist in a thawed or fermented form until being baked and prepared into final bread. As one preferred example, the bread dough composition may be shaped into a bread form of European-style hard bread such as ciabatta, campagne, batard, and baguette and frozen, and may be thawed and fermented immediately before being baked and prepared into bread after being stored in a frozen state.

As a specific example, the bread dough composition may be prepared through mixing, dividing, and shaping steps. First, the bread dough composition may be prepared in a dough form in which mixed raw materials are mixed and bound together into one, and during mixing, a temperature may preferably be 15 to 30° C., more preferably 17 to 25° C. Thereafter, the bread dough bound into one may be divided into a predetermined weight according to a size of bread to be prepared, and as one preferred example, may be divided into 150 to 250 g. The dough divided into a predetermined weight may be shaped into a desired shape, and the shaped bread dough may be rapidly frozen and stored in a frozen state. The rapid freezing may be performed, for example, at a temperature of −20° C. or less, preferably −30° C. or less, more preferably −35° C., for 10 minutes to 1 hour, preferably 20 to 45 minutes. After rapid freezing, a core temperature of a shaped bread dough may be 0° C. or less, preferably −2° C. or less.

In another embodiment of the present invention, bread is prepared from the bread dough composition, and as necessary, may be prepared by thawing and fermenting the bread dough composition and then baking. The bread may specifically be European-style hard bread such as campagne, ciabatta, batard, and baguette, and as one example, may be baguette-type bread such as French baguette and walnut baguette.

European-style hard bread is preferably required to have not only a uniform and even internal crumb texture, but also a thin outer crust thickness and a crusty texture. In the present invention, by preparing bread from a bread dough composition to which the bread improver composition is applied, it is possible to implement European-style hard bread, particularly baguette, having higher volume, a thin outer crust and improved crustiness, and improved internal crumb texture and flavor.

Specifically, upon thawing the bread dough composition for baking, the thawing temperature may be thawed until 10° C. to room temperature, preferably 15 to 25° C., and the thawing may be performed for 2 to 5 hours, preferably 3 to 4 hours. A core temperature of a thawed dough composition molded body may preferably be 15 to 25° C., more preferably 16 to 20° C.

Thereafter, upon fermenting the thawed bread dough composition, a fermentation temperature may be 20 to 35° C., preferably 25 to 30° C., and a fermentation time may be 30 to 120 minutes, preferably 40 to 90 minutes, specifically 50 to 60 minutes. In addition, during fermentation, a humidity condition may be 50 to 85 RH %, preferably 70 to 80 RH %.

Finally, bread may be prepared through a baking process in which the fermented bread dough composition is placed in an oven and baked. At this time, an oven temperature may be adjusted to 150 to 280° C., preferably 200 to 260° C. In addition, an upper temperature of the oven may be set higher than a lower temperature, and baking may be performed while applying steam. Baking may be performed for 15 to 30 minutes, preferably 20 to 30 minutes. As one example, the fermented bread dough composition may be baked for 20 to 25 minutes after applying steam for about 3 seconds under oven conditions of an upper temperature of 250° C. and a lower temperature of 230° C.

However, the fermentation and baking conditions are optimized for baguette-type bread, and depending on a type of bread prepared from the bread dough composition, fermentation conditions and baking conditions may be somewhat different in order to maximize volume, internal crumb texture, and mouthfeel.

As described above, the bread improver composition of the present invention, the bread dough composition comprising the same, and bread prepared therefrom can prepare bread having excellent volume, crust, internal crumb texture, and flavor by comprising vitamin C, amylase, and hemicellulase. Specifically, when applied to European-style hard bread, particularly baguette-type bread, volume, crust, internal crumb texture, and flavor are significantly improved, thereby providing bread having high preference from consumers.

### EXAMPLES

Hereinafter, the present invention will be described in more detail through Examples. However, these Examples are provided to illustrate some experimental methods and configurations for exemplary description of the present invention, and the scope of the present invention is not limited to these Examples. Various modifications or changes to the Examples may be made within the scope and technical spirit of the present invention, and such modifications or changes are also to be construed as being included in the claims of the present invention.

### Example 1: Preparation of French Baguette

First, as the improver composition of Table 1 below, an improver composition in which vitamin C, alpha-amylase (activity: 2,500 FAU/g), glucoamylase (activity: 1,000 AGU/g), and hemicellulase (xylanase, activity: 500 FXU/g) were blended at a weight ratio of 20:30:10:40 was used.

In order to prepare a French baguette, raw materials blended according to the composition of Table 1 below were first mixed, wherein malt extract powder was added in a dispersed manner, and dough was prepared by mixing under a temperature condition of 19.0±1° C. The dough was divided into portions of about 175 g each, rounded using a rounder, and shaped into a baguette shape, and then rapidly frozen at −35° C. or less for 30 minutes so that a core temperature of the frozen dough shaped body became −5±3° C. Thereafter, the dough shaped body was stored in a frozen state at −18° C. or less.

The frozen dough shaped body was thawed at 20° C. for 3 hours so that a core temperature of the shaped body became 18±1° C., and then fermented for 55 minutes under conditions of 28° C. and 75 RH %. The fermented dough shaped body was baked for 24 minutes after applying steam for 3 seconds in a deck oven (upper temperature: 250° C., lower temperature: 230° C.), thereby preparing a French baguette.

TABLE 1

| Raw materials | Parts by weight |
|---|---|
| Strong flour (containing 13 wt % protein) | 30 |
| French wheat flour (T65) | 70 |
| Purified water | 66 |
| Improver composition | 1 |
| Yeast | 2.2 |
| Salt | 1.8 |
| Malt extract powder | 0.7 |

### Experimental Example 1: Comparison of Finished Products According to Amount of Improver Composition

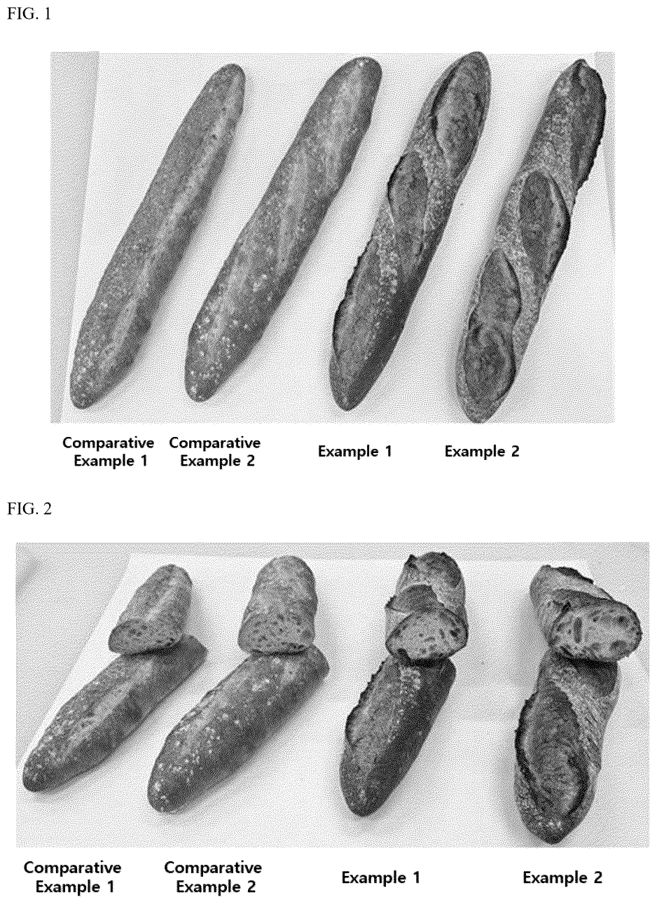

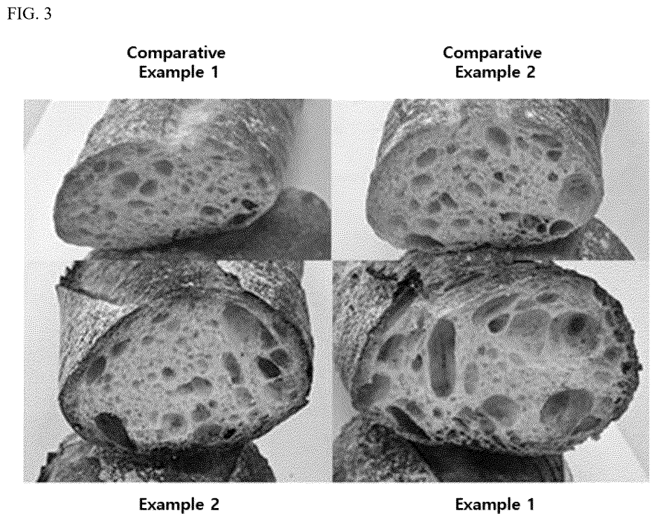

A French baguette was prepared in the same manner as in Example 1, except that Comparative Example 1 was prepared without adding an improver composition, Comparative Example 2 was prepared by replacing the improver composition with a conventional commercially available general improver, and Example 2 was prepared by adjusting an amount of the improver composition to 0.5 parts by weight based on 100 parts by weight of a total of strong flour and French wheat flour, and dough was shaped into the same shape and size and then baked to prepare finished products. Photographs of each prepared finished product are shown in FIGS. 1 and 2, and enlarged photographs of cross-sections of the finished products are shown in FIG. 3.

For finished product characteristics, first, a length of a long axis of the finished product and an area of an elliptical cross-section perpendicular to the long axis were visually observed to compare volume and volume feeling of each finished product, and pore formation and pore size in cross-sections of the finished products were visually observed and compared.

A crust thickness of an outer crust of the finished product was measured to confirm crust characteristics, and in addition, for internal crumb texture and flavor, a sensory evaluation on a scale of 1 to 10 points (10 points: excellent, 1 point: insufficient) was conducted with respect to 30 selected panelists to calculate an average value.

Referring to FIGS. 1 and 2, as compared with Comparative Example 1 prepared without adding an improver composition and Comparative Example 2 prepared using a commercially available general improver, Example 1 and Example 2 exhibited a longer long-axis length and a wider area of an elliptical cross-section perpendicular to the long axis, thereby confirming excellent volume. In particular, as can be confirmed in FIG. 3, Example 1 prepared with 1 part by weight of the improver composition exhibited higher volume, higher pore formation, and a larger average pore size as compared with Example 2 prepared with 0.5 parts by weight.

In addition, with respect to crust, as compared with Comparative Example 1 and Comparative Example 2, Example 1 and Example 2 exhibited a relatively thinner outer crust and a crispy texture, and in particular, Example 1 exhibited a thinner crust thickness than Example 2, thereby showing higher preference in crust characteristics and texture, and also recorded a significant preference difference in moistness of an internal crumb structure.

From this, it was confirmed that, according to the present invention, by adjusting an amount of the improver composition relative to wheat flour, bread having improved volume, outer crust, internal crumb texture, and flavor can be prepared.

### Experimental Example 2: Comparison of Finished Products According to Flour Composition

A product was prepared in the same manner as in Example 1, except that Example 3 was prepared using dough mixed by varying amounts of French wheat flour and strong flour. Specifically, Example 3 was prepared by changing the French wheat flour of Table 1 to 30 parts by weight and the strong flour to 70 parts by weight.

Example 1 and Example 3 were compared for characteristics of volume, crust characteristics, texture, and flavor of finished products using the same evaluation method as in Experimental Example 1.

As a result, volume of Example 3, in which the amount of French wheat flour was reduced to 30 parts by weight, was slightly decreased as compared with Example 1 and exhibited an acceptable level, however, in sensory evaluation of flavor, Example 1 exhibited a higher preference than Example 3, thereby showing a result that flavor varied depending on a difference in flour composition.

From this, it was confirmed that, according to the present invention, by comprising French wheat flour and strong flour together and adjusting a composition thereof, bread having improved volume, outer crust, internal crumb texture, and flavor can be prepared.

### Example 4: Preparation of Walnut Baguette

First, as the improver composition of Table 2 below, an improver composition in which vitamin C, alpha-amylase (activity: 2,500 FAU/g), glucoamylase (activity: 1,000 AGU/g), and hemicellulase (xylanase, activity: 500 FXU/g) were blended at a weight ratio of 20:30:10:40 was used.

In order to prepare a walnut baguette, raw materials blended according to the composition of Table 2 below were first mixed, wherein malt extract powder was added in a dispersed manner, and dough was prepared by mixing under a temperature condition of 22.0±1.5° C. The dough was divided into portions of about 180 g each, rounded using a rounder, and shaped into a baguette shape, and then rapidly frozen at −35° C. or less for 35 minutes so that a core temperature of the frozen dough shaped body became 6±1° C. Thereafter, the dough shaped body was stored in a frozen state at −18° C. or less.

The frozen dough shaped body was thawed at 20° C. for about 3 hours so that a core temperature became 18±1° C., and then fermented for about 55 minutes under conditions of 28° C. and 75 RH %. The fermented dough shaped body was baked for about 24 minutes after applying steam for 3 seconds in a deck oven (upper temperature: 250° C., lower temperature: 230° C.), thereby preparing a walnut baguette.

TABLE 2

| Raw materials | Parts by weight |
|---|---|
| Strong flour (containing 13 wt % protein) | 100 |
| Purified water | 65 |
| Improver composition | 1 |
| Walnut granule | 19 |
| Walnut powder | 1 |
| Yeast | 2.2 |
| Salt | 1.8 |
| Malt extract powder | 0.3 |
| Active gluten | 0.1 |

The finished walnut baguette prepared in Example 4 described above was also prepared by comprising 1 part by weight of the improver composition based on 100 parts by weight of strong flour, in the same manner as in Example 1 described above, thereby implementing high volume and thin and crispy crust characteristics.

From the above Examples and Experimental Examples, it was confirmed that, according to the present invention, by preparing bread by comprising a bread improver composition comprising vitamin C, amylase, and hemicellulase together with wheat flour and adjusting detailed conditions thereof, bread having excellent volume, outer crust, internal crumb texture, and flavor, particularly European-style hard bread, can be implemented.

From the foregoing description, those skilled in the art to which the present invention pertains will understand that the present invention may be implemented in other specific forms without changing the technical spirit or essential characteristics thereof. In this regard, the embodiments described above are to be understood in all respects as illustrative and not restrictive.

What is claimed is:

1. A bread improver composition comprising vitamin C (ascorbic acid), amylase and hemicellulase.

2. The bread improver composition of claim 1,
wherein the amylase comprises at least one selected from alpha-amylase (α-amylase) and glucoamylase.

3. The bread improver composition of claim 1,
wherein the hemicellulase comprises xylanase.

4. The bread improver composition of claim 1,
wherein the vitamin C is comprised in an amount of 10 to 40 wt % based on a total weight of the improver composition.

5. The bread improver composition of claim 1,
wherein the amylase is comprised in an amount of 20 to 60 wt % based on a total weight of the improver composition.

6. The bread improver composition of claim 2,
wherein a weight ratio of the alpha-amylase to the glucoamylase is 90:10 to 60:40.

7. The bread improver composition of claim 1,
wherein the hemicellulase is comprised in an amount of 20 to 60 wt % based on a total weight of the improver composition.

8. A bread dough composition comprising
the bread improver composition according to claim 1; and wheat flour.

9. The bread dough composition of claim 8,
wherein the bread improver composition is comprised in an amount of 0.1 to 2.0 parts by weight based on 100 parts by weight of the wheat flour.

10. The bread dough composition of claim 8,
wherein the wheat flour comprises French wheat flour and strong flour.

11. The bread dough composition of claim 10,
wherein a weight ratio of the French wheat flour to the strong flour is 20:80 to 90:10.

12. Bread prepared from the bread dough composition of claim 8.

13. The bread of claim 12,
wherein the bread is European-style hard bread.
